(19) United States
(12) Patent Application Publication
(10) Pub. No.: US 2004/0242141 A1
(43) Pub. Date: Dec. 2, 2004

(54) Spinal cord removing apparatus and carcass tilting device therefor

(75) Inventors: Shiro Ono, Kagoshima (JP); Koji Kusumoto, Kagoshima (JP)

Correspondence Address: MARSHALL, GERSTEIN & BORUN LLP, 6300 SEARS TOWER, 233 S. WACKER DRIVE, CHICAGO, IL, 60606, US

(73) Assignee: ITOHAM FOODS INC., Hyogo (JP)

(21) Appl. No.: 10/849,980

(22) Filed: May 20, 2004

(30) Foreign Application Priority Data
Sep. 10, 2002 (JP) 2002-263960

(51) Int. Cl. A22C 18/00

(52) U.S. Cl. 452/167

(57) ABSTRACT

A carcass tilting device equipped in a spinal cord removing apparatus for suctioning and removing spinal cord from spinal cavity of a carcass of slaughtered cattle, to facilitate removing spinal cord from the carcass suspended with its head down in a vertically narrow space, comprises a support column 21, a tilting member 23 pivotally mounted on the support column 21 and having a contact portion 25a with which the carcass makes contact, and a second cylinder 29 configured to cause the tilting member 23 to pivot to be tilted with respect to a vertical direction such that a lower end of the tilting member is raised. The tilting member 23 has an inner member 24 and an outer member 25 which are displaceable in the longitudinal direction from a position where the members 24 and 25 overlap each other, thereby causing the tilting member 23 to entirely extend.

### BACKGROUND OF THE INVENTION

1. Field of the Invention

The present invention relates to a spinal cord removing apparatus and a carcass tilting device therefor which are intended to treat a carcass of slaughtered cattle. More particularly, the present invention relates to an apparatus for removing spinal cord from a spinal cavity of a carcass of cattle such as beef cattle, and a carcass tilting device equipped in the spinal cord removing apparatus to tilt the carcass from which the spinal cord is to be removed.

2. Description of the Related Art

In recent years, various examples of diseases caused by abnormal prion proteins (hereinafter also referred to as prion diseases) have been reported, among which bovine spongiform encephalopathy (BSE) (generally called mad cow disease), or scrapie of sheep and goat are representative. The prion diseases are progressive nerve system diseases. Cattle is infected by abnormal prion proteins by biosynthesis or ingestion. Brain tissues of the cattle are destroyed by the abnormal prion proteins accumulated in brain or nerve. And finally, the brain of the cattle is denatured in the form of sponge, which brings about the infective cattle' death.

It has been believed that infectivity by the abnormal prion proteins is not substantially affected by heating sterilization, irradiation sterilization, or drug solution sterilization, unlike in the microbes such as virus or bacteria, which are causes of general infective diseases. Therefore, in order to prevent infection by the abnormal prion proteins, it is essential that ingestion of such abnormal prion proteins into a body, for example, by eating them, be avoided.

It has been confirmed that in the cattle infected with the prion diseases, the abnormal prion proteins unevenly exist in brain, spinal cord, eyes, or intestinum ileum distal parts, which are specified as dangerous parts. So, by way of precaution, efforts are being directed to improving safety by completely removing the dangerous parts of even the beef cattle that have passed the above-stated tests.

The cattle is typically dissected and made into meat products through the process: slaughtering the cattle and letting the cattle bleed, removing bone, hoof, tail part, and so forth, tearing off skin, cutting off head, splitting thoracic part, removing visceral organs, splitting dorsal part to produce dressed carcass, cooling, removing bone, and dividing. Among the dangerous parts, the brain, the eyes, and the intestinum ileum distal parts can be removed relatively easily without contaminating operators or parts to be eaten by cutting off the head and removing the visceral organs. However, there is a possibility that the spinal cord scatters and contaminates the parts to be eaten or the operators when the spinal cord is scraped after the dorsal part is split.

In view of the above, it is desirable to remove the spinal cord before splitting the dorsal part. Accordingly, there has been proposed a method of pushing out the spinal cord from the head part by feeding air under high pressure from lumbar part. However, in this method, the parts to be eaten are crushed into pieces or damaged by the high air pressure. This reduces a commercial value of the meat. Further, the spinal cord tends to scatter by the application of the air pressure, which probably contaminates floor of work area.

Accordingly, the inventors have disclosed an apparatus for suctioning and removing spinal cord by inserting a suction nozzle into spinal column (spinal vertebrae) of a carcass (see Japanese Laid-Open Patent Application Publication Nos. 2003-169595 and 2003-304803).

### SUMMARY OF THE INVENTION

Under the circumstances, the present invention has been developed, and an object of the present invention is to provide improvements in the apparatus disclosed in the above publications, specifically, a carcass tilting device that facilitates an operation to a carcass suspended (hung) with its head down even in a vertically narrow space, in addition to an apparatus capable of removing spinal cord from beef cattle while inhibiting contamination and keeping a commercial value of beef cattle.

According to one aspect of the present invention, there is provided a carcass tilting device equipped in a spinal cord removing apparatus configured to suction and remove spinal cord from a spinal cavity of a carcass of slaughtered cattle, the device comprising: a support body; a tilting member pivotally mounted on the support body, the tilting member having a contact portion with which the carcass makes contact; and a drive unit configured to cause the tilting member to pivot to be tilted with respect to a vertical direction such that a lower end of the tilting member is raised.

When the carcass is suspended by holding the hind leg, a cut end (around a neck of the cattle) of the spinal column on a head side is near the floor, in which case, suction nozzles are difficult to insert into the spinal cavity. But, by bringing the tilting member into contact with the carcass and tilting the carcass so that its neck side is raised, an operator can easily insert the suction nozzles into the spinal cavity of the carcass.

Typically, the spinal column of the beef cattle is curved such that an angle is made between cervical vertebrae and thoracic vertebrae. By tilting the carcass with its dorsal side in contact with the tilting member, a curvature of the spinal column of the carcass is somewhat straightened by a reactive force from the tilting member relative to the weight of the carcass. This facilitates insertion of the suction nozzles into the spinal cavity.

Preferably, the tilting member is pivotable around an upper end thereof, or the tilting member is pivotable around an intermediate point between the upper end and a lower end thereof. When the tilting member is pivotable around the upper end, a structure of the tilting device is simple. And, when the tilting member is pivotable around the intermediate point, weight of the tilting member or weight of the carcass is used as a drive force for tilting. Therefore, a drive unit which outputs a low power can be used.

Preferably, the tilting member includes a plurality of tilting elements which are displaceable relative to each other in a longitudinal direction of the elements from a position where the elements overlap each other, thereby causing the tilting member to extend. This simplifies a construction of the tilting device.

Preferably, the carcass tilting device further comprise a carcass press member mounted in the vicinity of a lower end of the tilting member so as to be advanceable from the contact portion of the tilting member toward the carcass and retractable from the contact portion. Since the press member presses the lower end of the spinal column of the carcass in the direction from the dorsal side to the thoracic side, the curvature of the spinal column is straightened. This further facilitates insertion of the suction nozzles into the spinal cavity of the carcass.

Preferably, the carcass press member includes a press portion mounted at a tip end of the tilting member to be pivotable to advance from a surface of the contact portion with which the carcass makes contact toward the carcass and to retract from the surface of the contact portion, and a drive unit mounted on the tilting member to drive the press portion to pivot.

Also, preferably, the tilting member is horizontally movable to be away from and close to the support body. Such a structure allows the tilting member to effectively contact the suspended carcass carried to the work area.

According to another aspect of the present invention, there is provided a spinal cord removing apparatus comprising: a suction nozzle configured to suction spinal cord from a spinal cavity of a carcass of slaughtered cattle; and a carcass tilting device including: a support body; and a tilting member pivotally mounted on the support body, the tilting member having a contact portion with which the carcass makes contact; and a drive unit configured to cause the tilting member to pivot to be tilted with respect to a vertical direction such that a lower end of the tilting member is raised.

The above and further objects and features of the invention will more fully be apparent from the following detailed description with accompanying drawings.

### BRIEF DESCRIPTION OF THE DRAWINGS

FIG. 1 is a schematic view showing an embodiment of a spinal cord removing apparatus according to the present invention;

FIG. 2 is a side view showing an example of nozzles of the spinal cord removing apparatus and a carcass to be treated by the spinal cord removing apparatus;

FIG. 3 is a side view showing an embodiment of a carcass moving device and a carcass tilting device in the spinal cord removing apparatus in FIG. 1;

FIG. 4A is a plan view of a tilting member of the carcass tilting device;

FIG. 4B is a rear view of the tilting member;

FIG. 4C is a bottom plan view of the tilting member;

FIG. 5 is a transverse cross-sectional view of the tilting member in the carcass tilting device in FIG. 3;

FIG. 6 is a side view showing a tilted state of the carcass tilting device in FIG. 3; and

FIG. 7 is a side view showing another embodiment of the carcass tilting device of the present invention.

### DETAILED DESCRIPTION OF THE PREFERRED EMBODIMENTS

Hereinafter, embodiments of a spinal cord removing apparatus and a carcass tilting device therefor of the present invention will be described with reference to the drawings. The present invention is not intended to be limited to these embodiments.

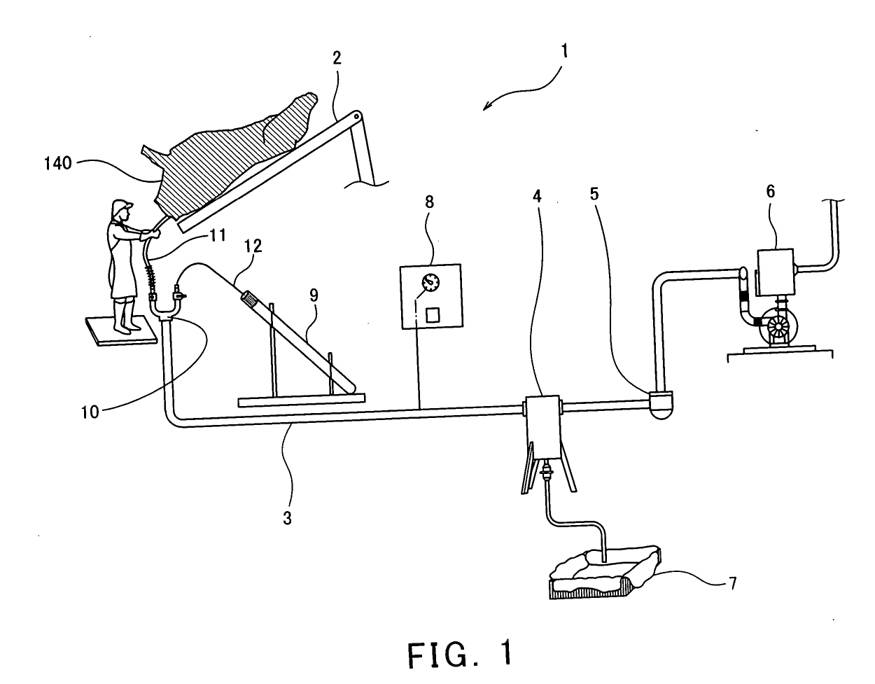

With reference to FIG. 1, a spinal cord removing apparatus 1 comprises a first nozzle 11 and a second nozzle 12 which are inserted into a spinal cavity of a carcass 140 of slaughtered cattle to suction and remove spinal cord, a suction pipe 3 connected to the suction nozzles 11 and 12, a vacuum tank 4, a vacuum filter 5 and a vacuum pump 6, which are connected to the suction pipe 3. A collecting container 7 into which the suctioned spinal cord is collected is connected to the vacuum tank 4. The spinal cord is suctioned under a pressure of about 12 to 15 in.Hg. A meter 8 is a pressure meter or the like.

The first nozzle 11 has a large diameter and the second nozzle 12 has a small diameter. The first nozzle 11 has an outer diameter of 12 to 17 mm and an inner diameter of 9 to 15 mm. The second nozzle 12 has an outer diameter of 9 to 14 mm and an inner diameter of 5 to 10 mm.

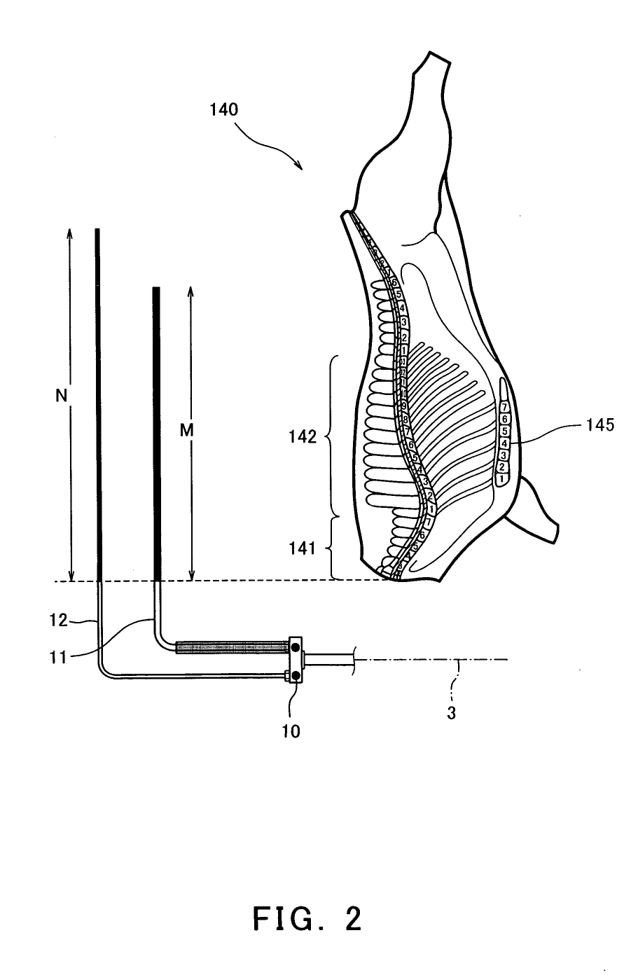

In this embodiment, the nozzles 11 and 12 are inserted into the spinal cavity of the carcass 140 from its head side. By way of example, as shown in FIG. 2, the first nozzle 11 is inserted to reach a sixth lumbar vertebra as represented by M, while suctioning the spinal cord, and then, after pulling out the first nozzle 11, the second nozzle 12 is inserted to sacral vertebrae as represented by N while suctioning the spinal cord. Since the spinal column (vertebrae) is generally thinner as it is closer to a tail part, the two types of nozzles are used in two steps, respectively. In FIG. 2, reference numeral 141 denotes cervical vertebrae, 142 denotes thoracic vertebrae, and 145 denotes sternal bone.

The first and second nozzles 11 and 12 are connected to the suction pipe 3 of the spinal cord removing apparatus 1 through a switching device 10. The switching device 10 serves to perform switching of a suction path between the nozzles 11 and 12 and stop suction of the nozzles 11 and 12. In addition, the spinal cord removing apparatus 1 is equipped with a sterilization container 9 that immerses the nozzles 11 and 12 in a sterilizer to sterilize them.

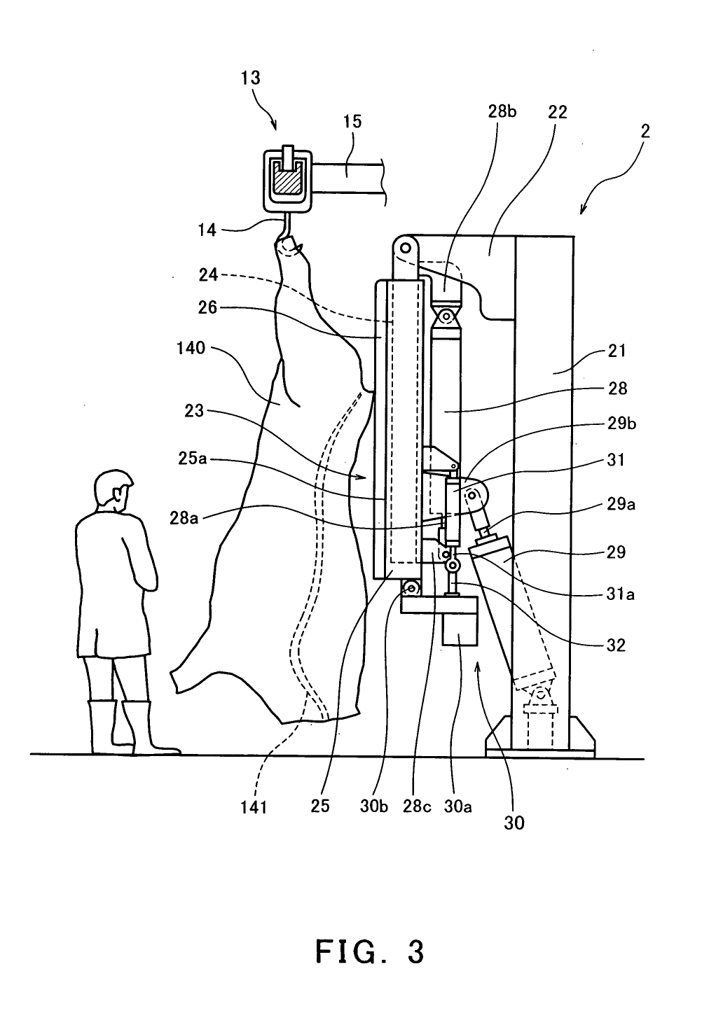

As shown in FIG. 3, a moving device 13 is provided to suspend the carcass 140 to be treated and carry the suspended carcass 140 to a work area. The carcass 140 is obtained by tearing the skin off from the tip end side of hind leg, cutting the head, cutting off the thoracic part, and removing visceral organs. The moving apparatus 13 includes a hook 14 that suspends the carcass 140 by holding the hind leg, and a rail 15 that guides movement of the hook 14. And, a carcass tilting device 2 is equipped in the spinal cord removing apparatus 1 to tilt the carcass 140 in the work area. When suctioning the spinal cord from the carcass 140, the nozzles 11 and 12 are inserted from the head side of the carcass 140 suspended with the hind leg held by the hook 14 as described above into the spinal cavity. In a vertically narrow space, since the rail 15 is located lower and hence the head side of the spinal column of the suspended carcass 140 is near the floor, the nozzles are sometimes extremely difficult to insert. For this reason, the carcass tilting device 2 tilts the suspended carcass 140 so that its lower end (head side) is pushed up. By doing so, a part of the suspended carcass 140 into which the nozzles are to be inserted are raised and positioned for an operator to easily insert the nozzles into the carcass 140.

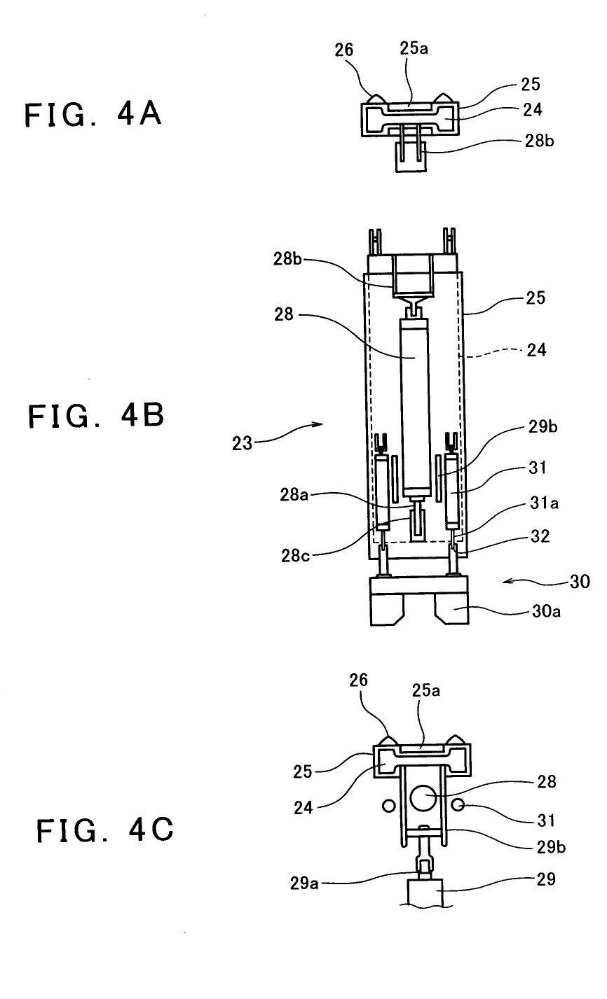

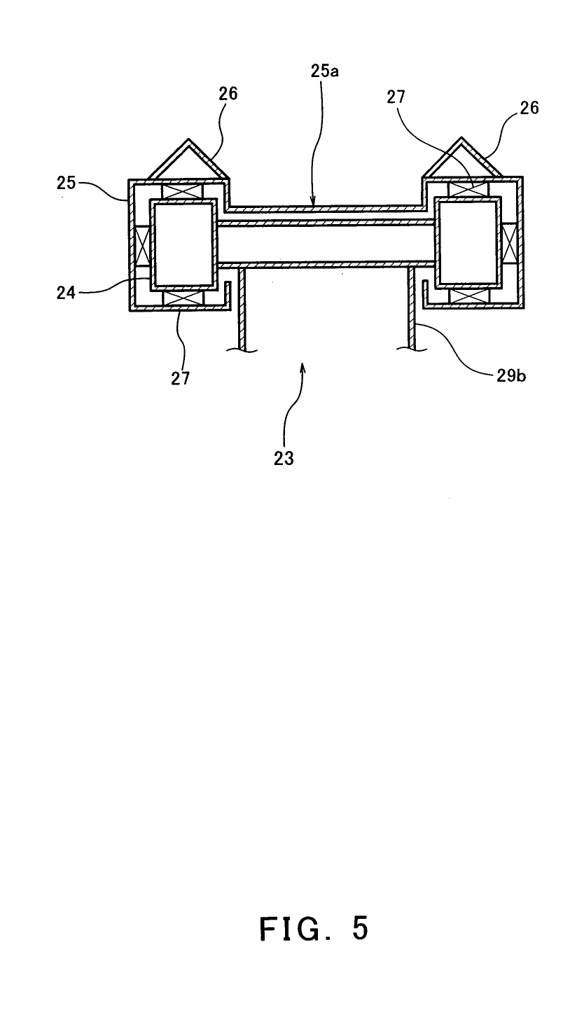

FIG. 4A to FIG. 6 show a detailed construction of the carcass tilting device 2. FIG. 4A is a plan view of the tilting member of the carcass tilting device 2. FIG. 4B is a rear view of the tilting member. FIG. 4C is a bottom plan view of the tilting member. FIG. 5 is a transverse cross-sectional view of the tilting member. The carcass tilting device 2 is constructed such that a support column 21 as a support body is fixed to the floor. Instead, the carcass tilting device 2 may be provided with caster or drive wheels. A support bracket 22 is mounted to an upper end of the support column 21. From the support bracket 22, the tilting member 23 extends downward to be pivotable. The tilting member 23 is adapted to make contact with the carcass 140 suspended by the moving device 13. More specifically, the tilting member 23 is pivotally supported at the upper end by the bracket 22.

The tilting member 23 is telescopically extensible and contractible. Specifically, the tilting member 23 is configured to extend and contract its total length according to a length of the carcass 140. The tilting member 23 is formed by two tilting elements. The tilting elements are an inner member (inner tube) 24 having a cross-section substantially in H-shape and an outer member (outer tube) 25 having a cross-section substantially in H-shape which is externally fitted to the inner member 24. As a matter of course, in a case where there is a sufficient vertical space in the work area, a tilting member having a length that covers a wide range of length of the carcass 140 may be used in place of the telescopic tilting member 23. Two guide protrusions 26 are provided on a contact portion 25a of the outer member 25 with which the carcass 140 makes contact, to extend along the longitudinal direction of the outer member 25. The guide protrusions 26 enable the carcass 140 to be placed stably on the tilting member 23. The guide protrusions 26 are spaced apart from each other in a width direction of the outer member 25 to allow the carcass 140 to be placed between them.

As shown in FIG. 5, a slide shoe (slide guide) 27 made of synthetic resin is provided between the inner member 24 and the outer member 25. The slide shoe 27 may be provided on at least one of the inner member 24 and the outer member 25. A first cylinder 28 is pivotally supported at a base portion thereof by a support bracket 28b formed in the vicinity of an upper end of the inner member 24 to drive the tilting member 23 to extend and contract. The first cylinder 28 has a rod 28a supported at a tip end thereof by a bracket 28c provided in the vicinity of a lower end of the outer member 25. When the rod 28a extends, the outer member 25 moves downward from a position where the outer member 25 overlaps with the inner member 24. Thereby, the entire tilting member 23 extends.

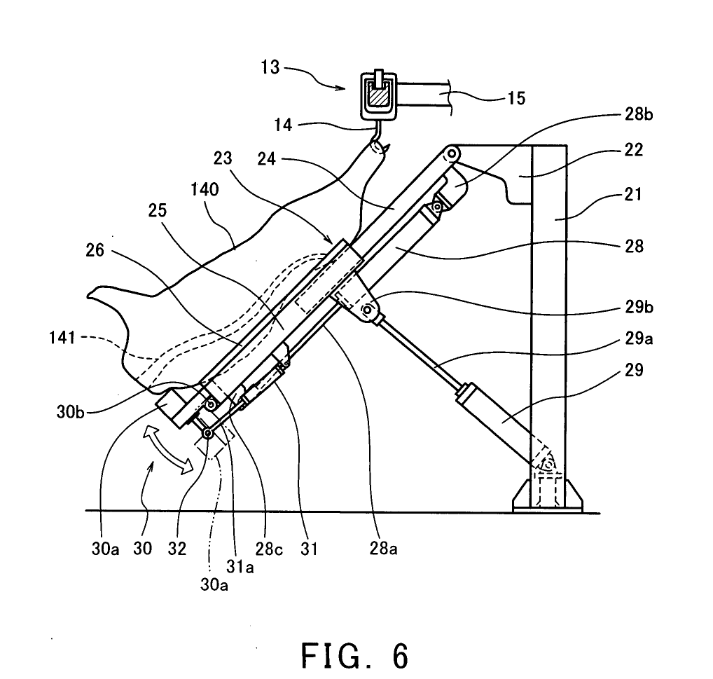

In order to tilt the tilting member 23 from a vertical direction, a second cylinder 29 is pivotally supported at a base portion thereof by a lower part of the support column 21 to drive the tilting member 23 to pivot. And, a rod 29a of the second cylinder 29 is pivotally supported at a tip end thereof by a mounting bracket 29b provided on a lower part of a back surface of the inner member 24 which is on the opposite side of the contact portion 25a of the tilting member 23. When the rod 29a extends, the tilting member 23 pivots around a pivot portion at the upper end such that the lower end thereof is pushed up (see FIG. 6). In this embodiment, a pivot angle (tilting angle) with respect to the vertical direction is set to about 45 degrees, but is not intended to be limited to this. The pivot angle may be set to more than or less than 45 degrees.

Typically, the carcass tilting device 2 is installed on a relatively narrow vertical space in a factory. And, the support column 21 has a small height. With the tilting member 23 suspended in the vertical direction, the outer member 25 will contact the floor, if extended. downward. So, it is necessary to tilt the tilting member 23 such that the lower end is raised before extending the outer member 25.

A press member 30 is mounted on a lower end of the outer member 25 to be advanceable and retractable from a surface of the contact portion 25a. The press member 30 displaces to push a vicinity of a lower end of the suspended carcass 140 away from the contact portion 25a (see FIG. 6). As shown in FIG. 3, the press member 30 is pivotally supported at a base portion thereof by a lower end of the outer member 25 by means of a pin 30b. The press member 30 is driven to pivot by a pair of third cylinders 31 (see FIG. 4B) attached on a back surface of the outer member 25. Rods 31a of the third cylinders 31 are connected to the press member 30 through knuckle joints 32. The press member 30 is provided with protruding press portions 30a. When the rods 31a of the third cylinders 31 extend, the press member 30 pivots toward the contact portion 25a, thereby causing the press portions 30a to protrude from the surface of the contact portion 25a with which the carcass 140 is in contact toward the carcass 140. When the rods 31a contracts, the press portions 30a retract from the surface of the contact portion 25a to be away from the carcass 140.

Instead of the pivotable press member 30, a member linearly protrusible and retractable from the surface of the contact portion 25a may be built in a lower part of the outer member 25.

Subsequently, how the carcass tilting device 2 is used will be described. As shown in FIG. 3, the carcass tilting device 2 is suspended vertically downward with the tilting member 23 shortened. A large-sized carcass (beef cattle) suspended with hind leg held by the hook 14 is carried to the spinal cord removing apparatus 1, and positioned so that its dorsal part can contact the tilting member 23. As shown in Fig. 3, a part of the length of the carcass 140 is not covered with the tilting member 23. So, the tilting member 23 may be tilted immediately, or after extending the outer member 25 so as not to reach the floor.

Then, as shown in FIG. 6, the tilting member 23 is operated to cause the carcass 140 to be tilted for operator to work easily. Then, the outer member 25 is extended. The carcass 140 is placed with the dorsal part on the tilted contact portion 25a. As shown in FIG. 2, spinal column of some beef cattle is greatly curved such that an angle made between cervical vertebrae 141 and thoracic vertebrae 142 is below 70 to 80 degrees. So, when inserting the nozzle into the spinal cavity, the nozzle is difficult to insert into the thoracic vertebrae 142.

However, by placing the carcass 140 on the contact portion 25a with the dorsal part down, the curvature of the spinal column of the carcass 140 is somewhat straightened by a reactive force from the contact portion 25a with respect to the weight of the carcass 140. Under this condition, the nozzle can be easily inserted into the spinal cavity. When the press member 30 is operated, the press portion 30a presses a lower end of the spinal column of the carcass 140 in the direction from the dorsal side to the thoracic side. Thereby, the curvature of the spinal column is further straightened, which further facilitates insertion of the nozzle into the spinal cavity.

The cylinders 28, 29 and 31 may be air cylinders or hydraulic cylinders. Instead of the cylinders, known means such as feed screw means driven by the motor may be used.

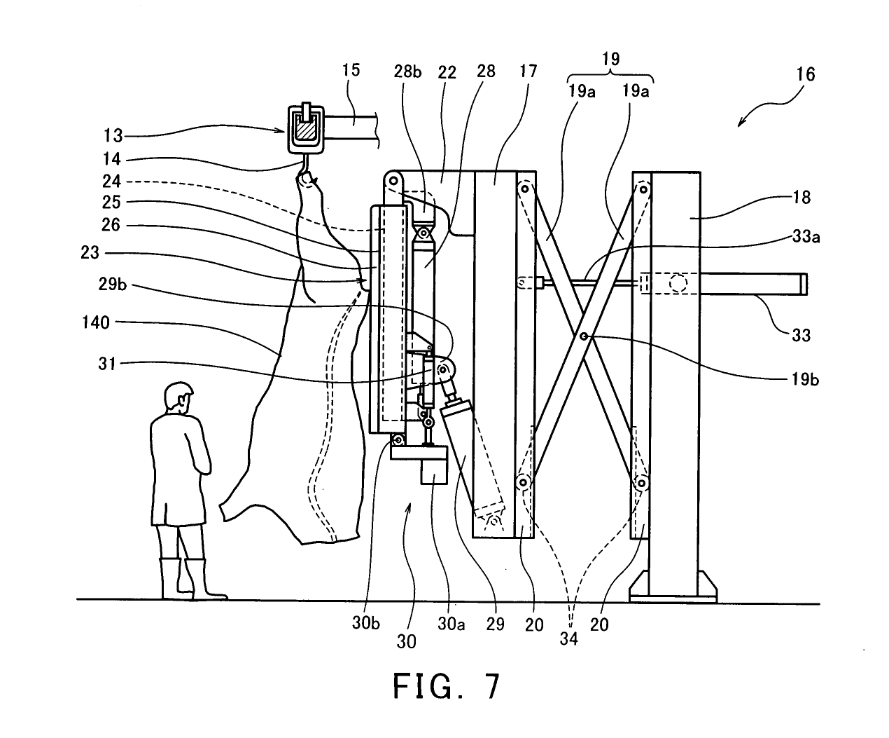

FIG. 7 shows another carcass tilting device 16. The device 16 is configured such that the device 2 in FIGS. 3 to 6 moves toward the carcass 140 (to the left in FIG. 7). Specifically, a support column 17 corresponding to the support column 21 in FIGS. 3 to 6 is not installed on the floor but a support column 18 is installed on the floor. And, the support column 17 is movably mounted on the support column 18. Therefore, herein, the support column 17 is named a movable support member 17. The movable support member 17 is mounted on the support column 18 through a link arm 19 of a pantograph type.

The link arm 19 is configured such that two rod members 19a cross each other and are connected to each other by a pin 19b at a cross point to be rotatable relative to each other. The rod members 19a are pivotally supported at upper ends thereof by the movable support member 17 and the support column 18, respectively. Engagement rollers 34 are mounted on lower ends of the rod members 19a. The engagement rollers 34 movably engage with guide rails 20 respectively formed in a longitudinal direction of the movable support member 17 and the support column 18. And, a fourth cylinder 33 is pivotally supported by the support column 18 to extend substantially in a horizontal direction and configured to move the movable support member 17. As shown in FIG. 7, a rod 33a of the fourth cylinder 33 is connected at a tip end thereof to the movable support member 17. So, when the rod 33a extends, the movable support member 17 is pushed to move away from the support column 18 (to the left in FIG. 7). The movable support member 17 moves away from the support column 18 and is brought into contact with the suspended carcass 140 carried to the work area. In FIG. 7, since the other construction is identical to that of the device 2 in FIGS. 3 to 6, the same parts as those in the device 2 in FIGS. 3 to 6 are identified by the same reference numerals, and will not be further described.

In the carcass tilting devices 2 and 16 described thus far, the tilting member 23 pivots around its upper end and is thereby tilted. But, this is intended to be illustrative only and not to be limiting of the invention. For example, the tilting member 23 may pivot around a desired point in an intermediate portion including a center portion in the longitudinal direction of the tilting member 23. In this structure, since weight of the tilting member 23 or the carcass 140 can be utilized, a cylinder that outputs a small power can be selected as the second cylinder. In the telescopic tilting member 23 comprised of the outer member 25 and the inner member 24, a pivot may be located in the vicinity of the lower end of the inner member 24.

Numerous modifications and alternative embodiments of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention and all modifications which come within the scope of the appended claims are reserved.

What is claimed is:

1. A carcass tilting device equipped in a spinal cord removing apparatus configured to suction and remove spinal cord from a spinal cavity of a carcass of slaughtered cattle, the device comprising:
a support body;
a tilting member pivotally mounted on the support body, the tilting member having a contact portion with which the carcass makes contact; and
a drive unit configured to cause the tilting member to pivot to be tilted with respect to a vertical direction such that a lower end of the tilting member is raised.

2. The carcass tilting device according to claim 1, wherein the tilting member is pivotable around an upper end thereof.

3. The carcass tilting device according to claim 1, wherein the tilting member is pivotable around an intermediate point between the upper end and a lower end thereof.

4. The carcass tilting device according to claim 1, wherein the tilting member includes a plurality of tilting elements which are displaceable relative to each other in a longitudinal direction of the elements from a position where the elements overlap each other, thereby causing the tilting member to extend.

5. The carcass tilting device according to claim 1, further comprising a carcass press member mounted in the vicinity of a lower end of the tilting member so as to be advanceable from the contact portion of the tilting member toward the carcass and retractable from the contact portion.

6. The carcass tilting device according to claim 5, wherein the carcass press member includes:
a press portion mounted at a tip end of the tilting member to be pivotable to advance from a surface of the contact portion with which the carcass makes contact toward the carcass and to retract from the surface of the contact portion, and
a drive unit mounted on the tilting member to drive the press portion to pivot.

7. The carcass tilting device according to claim 1, wherein the tilting member is horizontally movable to be away from and close to the support body.

8. A spinal cord removing apparatus comprising:
a suction nozzle configured to suction spinal cord from spinal cavity of a carcass of slaughtered cattle; and
a carcass tilting device including:
a support body; and
a tilting member pivotally mounted on the support body, the tilting member having a contact portion with which the carcass makes contact; and
a drive unit configured to cause the tilting member to pivot to be tilted with respect to a vertical direction such that a lower end of the tilting member is raised.
